(19) United States
(12) Patent Application Publication
(10) Pub. No.: US 2022/0180243 A1
(43) Pub. Date: Jun. 9, 2022

(54) System and method of suggesting machine learning workflows through machine learning

(71) Applicant: Atlantic Technical Organization, San Juan, PR (US)

(72) Inventor: Arturo Geigel, San Juan, PR (US)

(73) Assignee: Atlantic Technical Organization, San Juan, PR (US)

(21) Appl. No.: 17/115,362

(22) Filed: Dec. 8, 2020

(51) Int. Cl. G06N 20/00; G06F 17/16

(52) U.S. Cl. CPC G06N 20/00; G06F 17/16

(57) ABSTRACT

A system and method of processing a machine learning flows by decomposing the flows on an x-y grid and extracting relevant information about their utilization on a particular category of machine learning workflow. This information is utilized to extract N-gram sequences that can be used as training for a machine learning algorithm that will suggest to the user which operator to put in a new machine learning workflow.

### BACKGROUND OF THE INVENTION

### Field of the Invention

The present disclosure is directed to a system and method for providing assistance to complete machine learning on workflow engines that deal machine learning flows.

### Discussion of the Background

Current trends in machine learning are advancing at a rapid pace. As they become mainstream, machine learning implementations will shift focus from single module implementations or two to three modules to a complex web where dozens of machine learning algorithms alongside ETL operations are carried out. The complexity of this web on which multiple machine learning algorithms interact will strain the cognitive limitations of their creators. Some of these issues are already is being documented in other similar scenarios such as the one in Lost in transportation: Information measures and cognitive limits in multilayer navigation, by Riccardo Gallotti, Mason A. Porter, and Marc Barthelemy.

The present disclosure is directed at identifying commonalities in multiple machine learning flows by clustering similar flows based on an inclusion/exclusion criterion through properly encoding criteria of the required elements of processing a machine learning workflow.

This process is the first step in a more complex process of getting a machine learning algorithm to learn machine learning flows. Clustering machine learning flows helps in isolating commonalities that machine learning algorithms can use for learning the necessary patterns to construct similar machine learning workflows.

### DESCRIPTION AND SHORTCOMINGS OF THE PRIOR ART

While application platforms can offer some level of abstraction by providing graphical user interfaces, hiding the complexity of programming languages, there is still a cognitive overload possibility due to complex workflows that can be developed to manage complex data processing tasks.

U.S. Pat. No. 6,606,613 (the “'613 patent”) B1 describes task models to help users complete tasks. This prior art has several shortcomings which are outlined as follows. First, the '613 patent models a single user's tasks whereas the present disclosure aims at parallel processes of tasks which present a different solving paradigm. Second, the clustering used in the '613 patent of similar tasks is based on agglomerative hierarchical clustering and this works for segregating tasks based on intersections and the difference between graphs.

The problem that the present disclosure aims to solve is how to cluster the machine learning workflows not on merely graph properties but also properties of the workflow itself. Properties such as the type of operation and its adjacent operators play a crucial role in establishing a processing pipeline that describes segments of the workflow. The properties that are crucial for proper segregation of the workflows require that each segment of the workflow be described by the operation being done, the algorithm used, the type of data being processed, and the underlying processing infrastructure in a parallel environment. Each of these properties can be further broken down according to processing speed, algorithm complexity, particular operation optimization, etc. These elements are essential in describing each node of processing in a parallel environment which are separate from the graph itself. Further, the graph itself is not a useful concept in parallel operation due to timing issue that might make a difference in processing. Such shortcomings are overcome in the present disclosure by embedding the graph in a coordinate system which can be fitted according to the requirements of comparison.

U.S. Pat. No. 8,954,850 (the “'850 patent”) uses agglomerative clustering to assist the user in building a workflow. The objective of this prior art is to detect similar patterns of construction of a flow in terms of the nodes under each branch of the business process. The limitation of this approach is that objects classified within a branch are not treated as sequentially dependent. Such data is indispensable to describe time dependent and operation dependent flows.

Providing appropriate contextual information beyond the graph structure is essential to any accurate matching of workflows, which the prior art does not provide. Contextual information that is not present in the prior art that can be used as properties of the workflow are their appropriate position with regards to other elements, where they are going to be executed, whether multiple flows share the same sequential information and in what order and patterns of multiple operators in a sequence. Discriminating among sequences into different branches of the clusters is also not present in the prior art. All these shortcomings limit the prior art on the degree of accuracy of the automation that can be produced by such methods.

### BRIEF DESCRIPTION OF THE DRAWINGS

FIG. 1 shows a typical embodiment of a system that performs the functions of making machine learning workflows according to the teachings of the present invention.

FIG. 2 describes the physical layout of the typical execution environment on which the parallel execution will take place according to the teachings of the present invention.

FIG. 3 displays a graphical representation of the major components of an exemplary system that can perform the functions of making machine learning workflows according to the teachings of the present invention.

FIG. 4 shows the categories of graphical operator elements according to the teachings of the present invention.

FIG. 5 shows a database table of a particular implementation of operator types alongside identifying fields according to the teachings of the present invention.

FIG. 6 shows an example of general fields that make up the configuration parameters of an operator according to the teachings of the present invention.

FIG. 7 Shows an execution map representative of a machine learning workflow divided into a grid where operators can be identified within a particular workflow according to the teachings of the present invention.

FIG. 8 shows a table representation of descriptive fields of the operators according to the teachings of the present invention.

FIG. 9 describes the different components that make up a suggestion system according to the teachings of the present invention.

FIG. 10 shows a three-dimensional histogram displaying operators occurring on each column of the flow grid according to the teachings of the present invention.

FIG. 11 shows an adjacency matrix using the column position label and the operator label as ID according to the teachings of the present invention.

FIG. 12 shows a two-dimensional representation of the histogram displaying operators occurring on each column and their respective links based on the adjacency matrix to link operators per column into N-grams according to the teachings of the present invention.

FIG. 13 presents the process of constructing the N-gram sequence and using it to train a machine learning algorithm according to the teachings of the present invention.

FIG. 14 shows a graphical user interface that implements the output of the process according to the teachings of the present invention.

FIG. 15 illustrates the process of the interaction between the operator selection process and the user according to the teachings of the present invention.

### DETAILED DESCRIPTION OF THE PREFERRED EMBODIMENTS

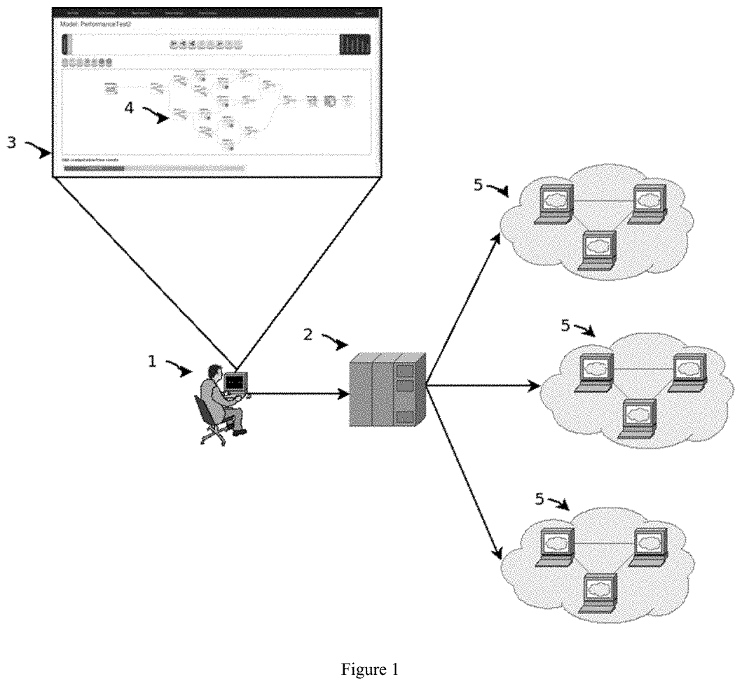

FIG. 1 Shows a typical embodiment of a system that performs the functions of making machine learning workflows. The system is accessed by a user through a terminal 1. The terminal 1 is connected to a central processing system 2 that contains memory components and processing units. The terminal accesses the functionality of the of the central processing system via an interface system 3 that has functionality icon 4. The central processing system 2 will process the information given by the interface system 3 and a functionality icon 4 to the terminal systems CPU and memory system or to a distributed architecture 5.

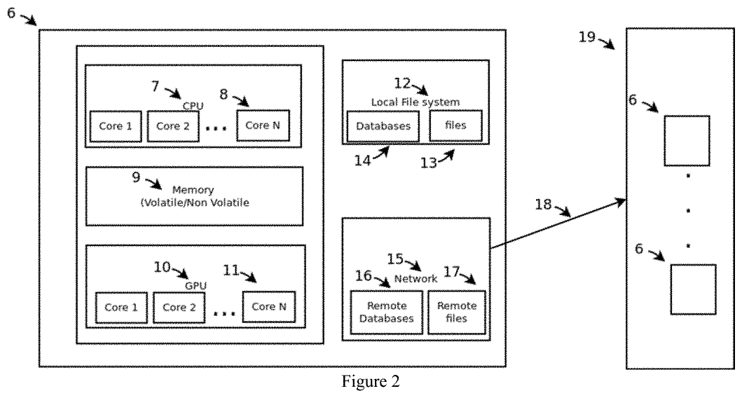

FIG. 2 describes an example of the physical layout of the typical execution environment on which the parallel execution takes place. A typical embodiment consists of a computer system 6 that contains a CPU 7 with a number of N cores 8. The N cores 8 are capable of doing multi-threading tasks on the CPU 7. The computer system 6 also contains a memory system capable of storing information for processing by the CPU 7. The computer system 6 can also contain a compute capable GPU 10 with a number of N cores 11. Computer system 6 has a local file system 12 that can contain several files 13 and possibly a database system 14. Computer system 6 includes a network interface 15 that can access a remote database system 16 or a remote file system 17. Access to remote database system 16 and/or a remote file system 17 is done through a network card in network 15 via a connection 18 to a cloud infrastructure 19. The cloud infrastructure 19 contains up to n computer systems 6.

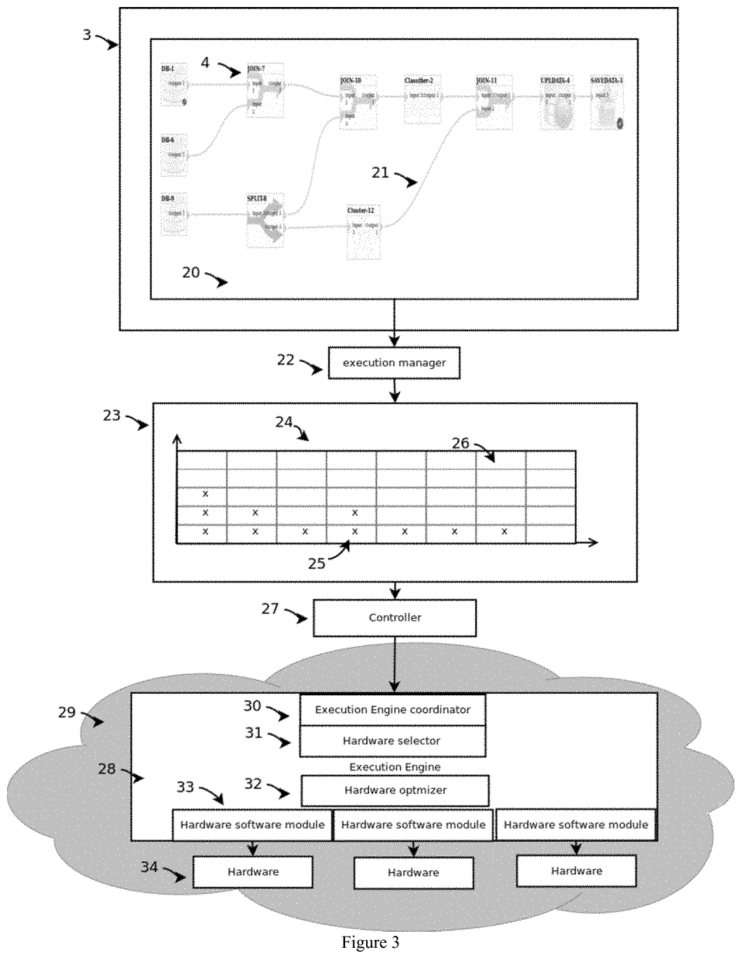

FIG. 3 Displays a graphical representation of the major components of an exemplary system that can perform the functions for making machine learning workflows. The system starts with the interface system 3 that has functionality icon 4, which contains the configuration that the system will execute. An execution program 20 is specified by the functionality icon 4 connected via a link 21. Once the execution program 20 is finished the program will be forwarded to an execution manager 22. The execution manager 22 will reside on the central processing system 2 which is a typical computer system 6. The execution manager will produce an execution map 23 based on the execution program 20. The execution map 23 contains an execution matrix 24 that will store the order of the execution. Each entry in the execution matrix 24 is assigned an execution slot 25 that can be filled with an execution entry 26 that corresponds to functionality icon 4. Once the execution map 23 is completed it is passed to a controller 27 that also resides central processing system 2. The controller coordinates the execution with an execution engine 28 across the cloud environment 29. Cloud environment 29 is composed of cloud infrastructure 19 that contains up to n computer systems 6. The controller 27 communicates to an execution engine coordinator 30 that resides on one of n computer systems 6 of cloud environment 29. The execution engine coordinator 30 uses a hardware selector 31 to discriminate which component of computer systems 6 should be used. For example, hardware selector 31 can choose between execution between the N cores 8 on the CPU 7 or use GPU 10 or other processing technology. Once hardware selector 31 chooses the particular processing technology, the hardware selector 31 selects a hardware optimizer 32 which coordinates with a hardware software module 33 that contains the necessary routines to interact with hardware 34.

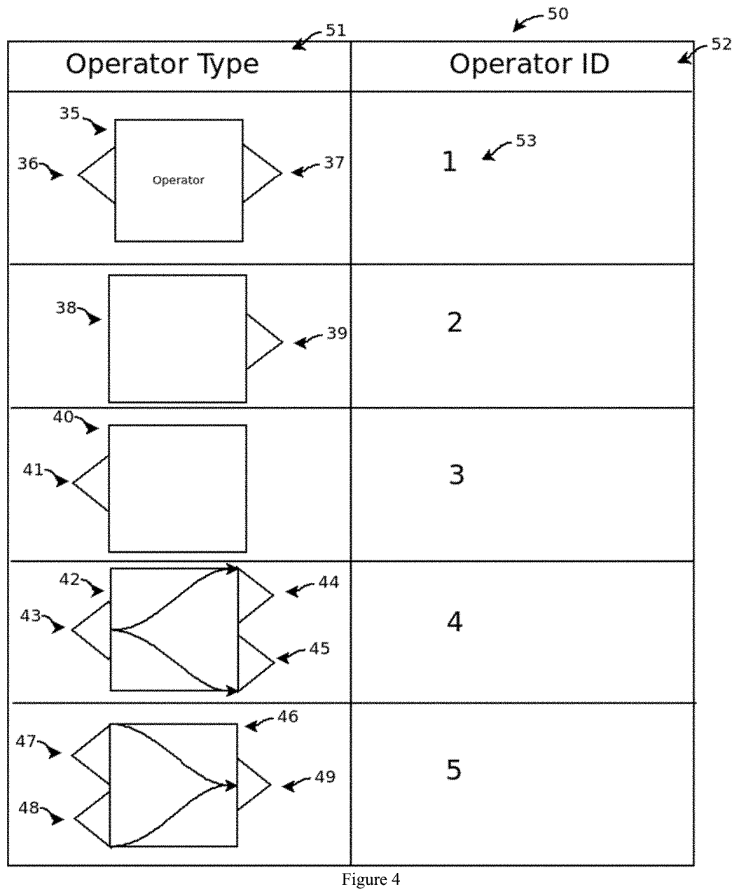

FIG. 4 shows the categories of graphical operator elements. Functionality icon 4 of interface system 3 can be divided into several icon types with specific functions that are independent of the particularity of the operations they are required to perform. FIG. 4 shows an operator 35 that has an input link connector 36 and an output link connector 37. The operator 35 represents an operation that has one input and one output. For example, this may represent a single instruction single datum (SISD) or single instruction multiple data operation (SIMD). An operator 38 contains an output link connector 39 representing a source operation. A source operation can be usually be taken but not limited to data extraction from a source that can be a database, file, web service, or other similar operation that does not accept an input to the operator. An operator 40 contains an input link connector 41 representing a destination operation. A destination operation can be usually be taken but not limited to data storage such as insertion to a database, file, web service or other operation that only accepts an input to the operator. An operator 42 represents a split operation. The operator 42 has an input link connector 43 that represents the input to the system. The operator 42 also contains an output link connector 44 and an output link connector 45. The split operation done by operator 42 takes one input through input link connector 43 and performs a split of the data into separate streams that are redirected to output link connector 44 and output link connector 45. Finally, an operator 46 represents a join operation. The operator 46 has an input link connector 47 and an input link connector 48. The operator 46 also contains an output link connector 49. The join operation carried out by operator 46 takes two data streams through input link connector 47 and input link connector 48 and joining the data stream into a single output that is sent to output link connector 49. The type of joining of data of operator 42 and splitting of data by operator 46 is independent of the operator type. A database table 50 can store the categories represented in operators 35, 38, 40, 42, 46 in a column 51 and have an operator ID column 52 storing an ID 53 that will be used to identify particular implementations of operators 35, 38, 40, 42, 46.

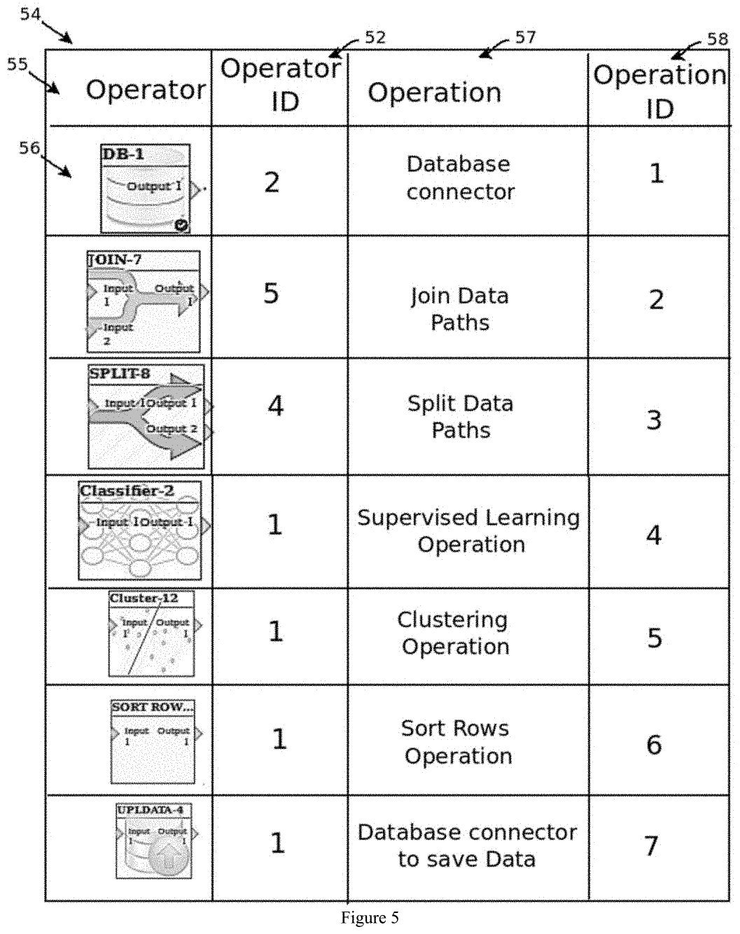

FIG. 5 shows a database table of an exemplary implementation of operator types alongside identifying fields. A database table 54 holds an operator field 55 that holds an operator 56. The operator 56 is given its diagrammatic form via functionality icon 4. The operator 56 is described by an operation field 57 that provides a description of what the operator does. The operator 56 is associated via database table 64 to operator ID column 52 of database table 50 via an operation ID field 58 thereby linking a particular operator with its type.

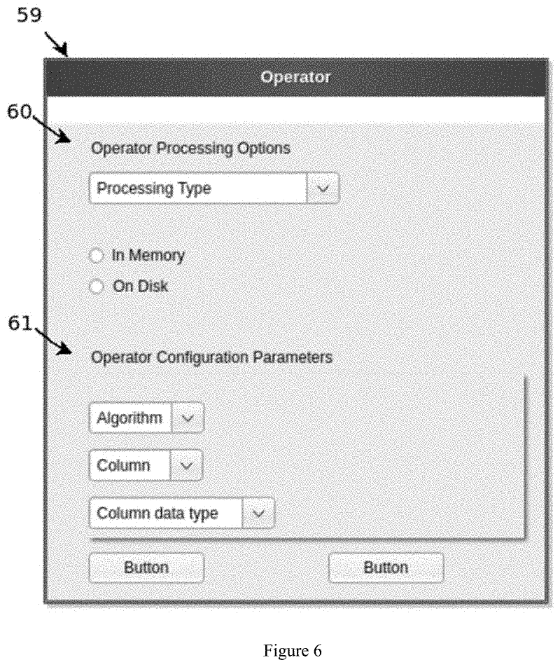

FIG. 6 shows an example of general fields that make up the configuration parameters of an operator. The operator 56 accessed on interface system 3 via functionality icon 4 which will then present a configuration window 59. The configuration window can have multiple configuration parameters. Such parameters can be divided into an operator processing options 60 and operator configuration parameters 61. Operator processing options 60 depend on the particular hardware options of terminal 1, the central processing system 2 and distributed architecture 5. Operator processing options 60 depend on the type of process or algorithm implemented and the data characteristics on which the operator will act upon.

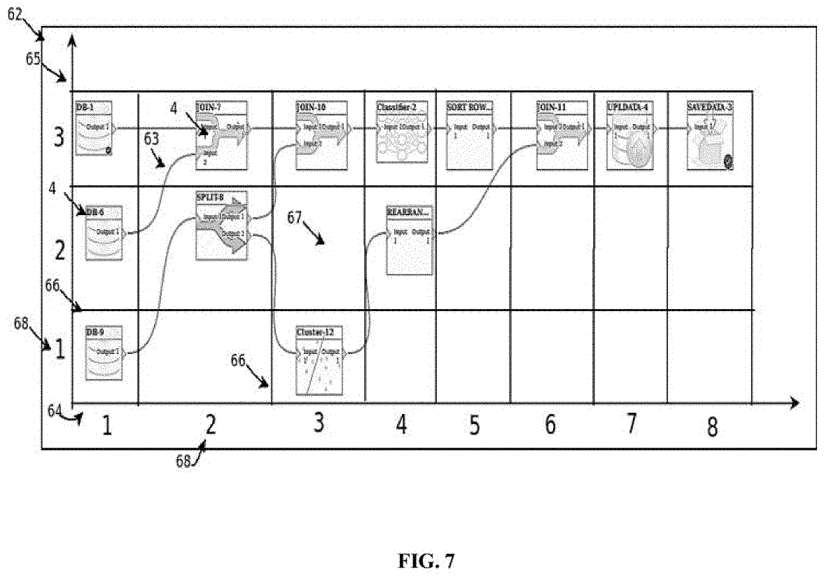

FIG. 7 shows an execution map representative of a machine learning workflow divided into a grid where operators can be identified within a particular workflow. A machine learning workflow 62 is representative of a typical machine learning flow. The flow is composed of functionality icons 4 which are joined by a workflow line 63. The machine learning workflow 62 can be put into a context of a grid by adding an x-grid line 64 and an y-grid line 65. The x-grid line 64 and the y-grid line 65 can each be divided by a line segments 66 that make up a square segment 67. Each segment 67 can then be identified by a number 68 on the x-grid line 64 and an y-grid line 65. The square segment 67 can be empty or populated by functionality icons 4. The functionality icon that is mapped to an operator 56 can give each square segment 67 a maximum number of line segments 66 depending on the description on database table 50 of operator 56. This particular implementation makes validation of the flow deterministic in nature.

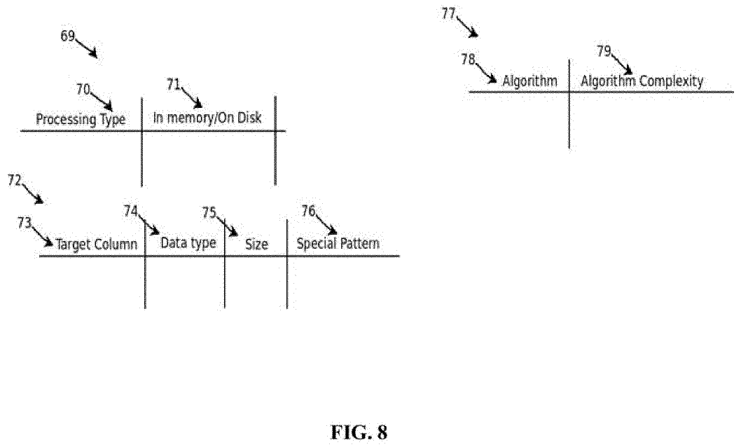

FIG. 8 shows a table representation of descriptive fields of the operators. A database table 69 shows properties of the operator 56 configuration that is done in configuration window 59 of FIG. 6. Database table 69 contains fields that belong to the particular hardware configuration parameters of the operator 56 such as a processing type field 70 that indicates whether it is single processor, multi core execution, GPU, etc., and a field 71 for in memory/on disk execution type. A database table 72 contains data parameters on which the operator 56 will execute on. A database table 72 contains attributes that belong to the data on which the operator 56 has been implemented on. The table 72 contains a column 73 which contains the target column of a file that has a vector format where each column belongs to a vector component. Table 72 also contains a column 74 that specifies the data type of the target data column identified in column 73. Column 73 can be represented as the column name, its position on the file, its identification number or a combination of fields or a composite of fields. Table 72 also contains a column 75 for the size of the data field. The size of the field can be interpreted as the number of characters of a string or the precision of a double precision number. The table 72 also contains a column 76 that holds particular patterns of the data such as those encoded by a regular expression or other such specification. A database table 77 contains information pertaining to the algorithm used in operator 56. The database table 77 contains information encoded in columns such as a table column 78 for the particular algorithm and a database table column 79 that specified the algorithm complexity of the particular algorithm implemented. This fields are not to be construed as the only fields to be included in database tables 69, 72 and 77 but as representative examples of each category of each respective table and the information to be stored in them.

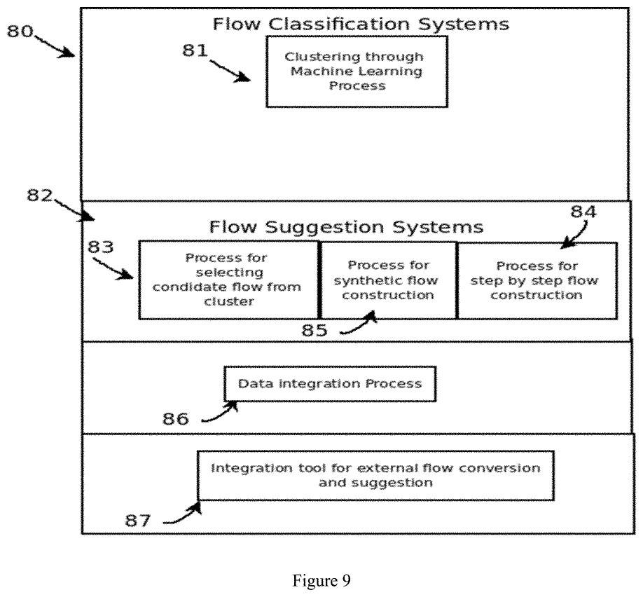

FIG. 9 describes the different components that make a suggestion system for classifying machine learning flows. A flow classification system 80 contains a subsystem 81 that implements clustering through machine learning processes. The flow classification process 80 also includes a subsystem 82 for machine learning workflow normalization and suggestion. The subsystem 82 of normalization flow suggestion system comprises of a subsystem 83 the enables the process of selecting a candidate flow from the clusters obtained in the classification process 80, a subsystem 84 of step by step construction of the machine learning workflow, and a subsystem 85 that does a synthetic workflow construction. This synthetic workflow does not select a candidate workflow but instead builds it completely based on the information available from the workflows in the cluster. The flow suggestion system also contains a subsystem 86 that can take the selected workflow from subsystem 83, subsystem 84, and subsystem 85 and checks and adjusts its workflow components according to the available data connections. The flow suggestion system further contains subsystem 87 for translation and integration with other similar applications.

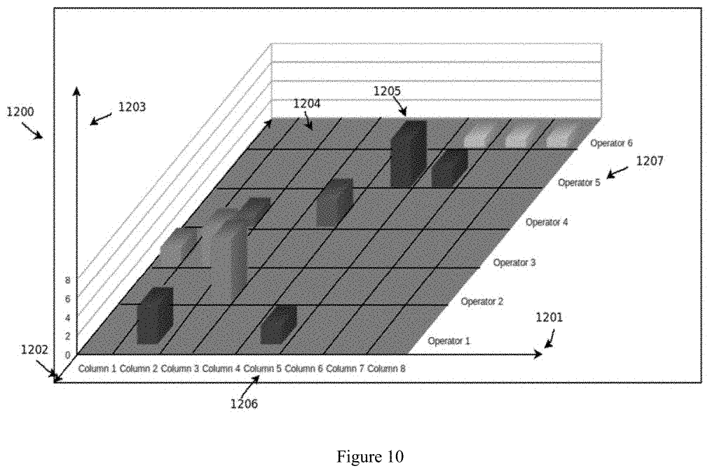

FIG. 10 shows a three-dimensional histogram displaying operators occurring on each column of the flow grid. A three-dimensional histogram 1200 uses an x-axis 1201, a y-axis 1202 and a z-axis 1203. The squares formed by the intersecting lines along the x-axis 1201 and y-axis 1202 form a histogram slot 1204. The frequency of an operator is plotted along the z-axis 1203 and forms a rectangular cuboid 1205. The histogram slot 1204 has the x-axis component that represents a column position label 1206. The histogram slot 1204 also has the y-axis 1202 that represents an operator label 1207. The three-dimensional histogram 1200 quantifies the operation ID 58 through the operator label 1207 on a per column basis using column position label 1206.

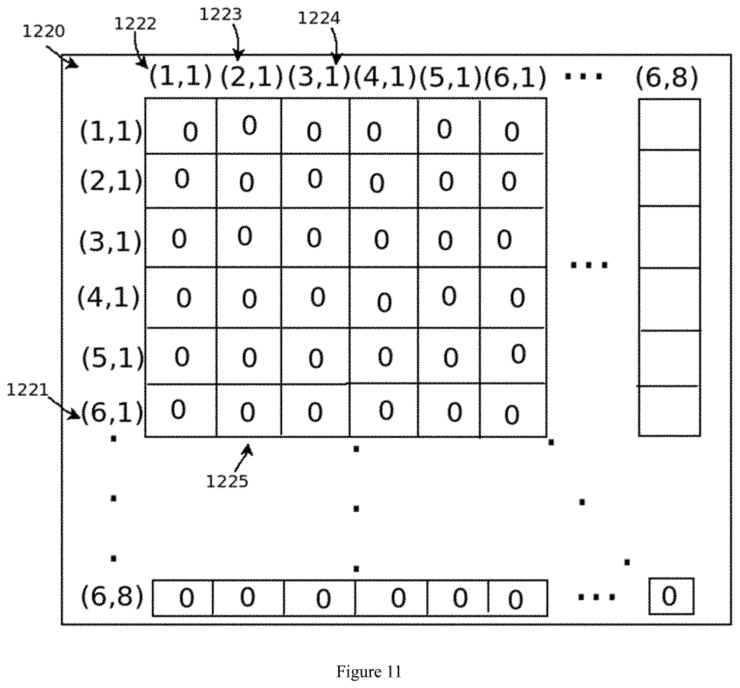

FIG. 11 shows an adjacency matrix using the column position label and the operator label as ID. An adjacency matrix 1220 is an adjacency matrix based on the three-dimensional histogram 1200 information and the links in the machine learning workflows utilized to construct the three-dimensional histogram 1200. The adjacency matrix 1220 has a row identifier 1221 and a column identifier 1222. The row identifier 1221 and column identifier 1222 are composed of a label 1223 that corresponds to the operator label 1207 and a label 1224 that corresponds to column position label 1206. The label 1223 and label 1224 uniquely identifies the operator ID 58 of operator 56. The information used to fill the adjacency matrix will be the connections from each of the flows considered on the histogram that are derived from flows using interface system 3. The links considered by the adjacency matrix is the cumulative counting of functionality icon 4 connected via a link 21 across multiple flows. An entry 1225 will represent the frequency of the links from an operator label 1207 in a column label 1206 to another operator label 1207 in the subsequent column label 1206.

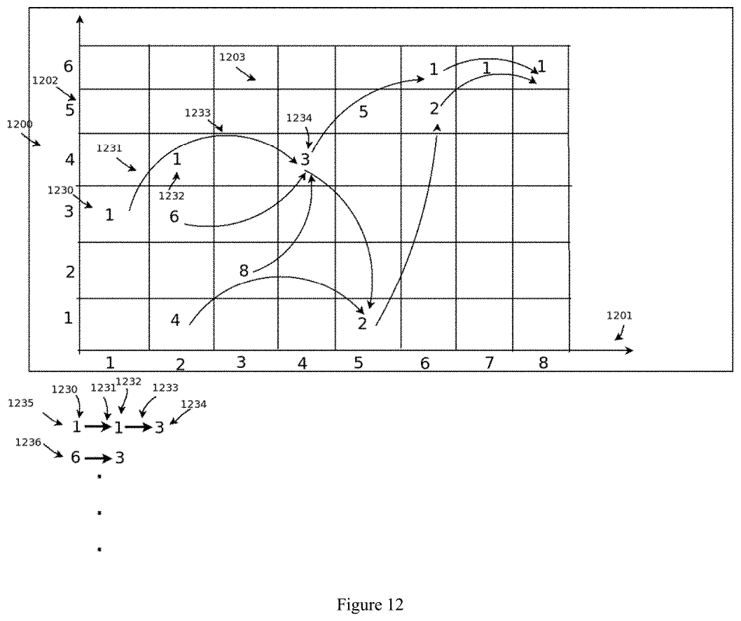

FIG. 12 shows a two-dimensional representation of the histogram displaying operators occurring on each column of the flow and their respective flows based on the adjacency matrix to link operators per column into N-grams. The three-dimensional histogram 1200 is displayed. An operator 1230 in one of the histogram slots 1204 has a link 1231 that corresponds to one link 21 in one or more machine learning flows and this links to an operator 1232. The link 1231 has a second link segment 1233 that links operator 1232 to an operator 1234. Below the three-dimensional histogram 1200 is an N-gram sequence 1235. The N-gram sequence is composed of operator 1230, link 1231, operator 1232, second link segment 1233 and operator 1234. A second N-gram sequence 1236 is also extracted to represent a single bigram sequence that is an example of the minimum N-gram extracted from the map. The sequence length is taken from the highest N-gram extracted from the map.

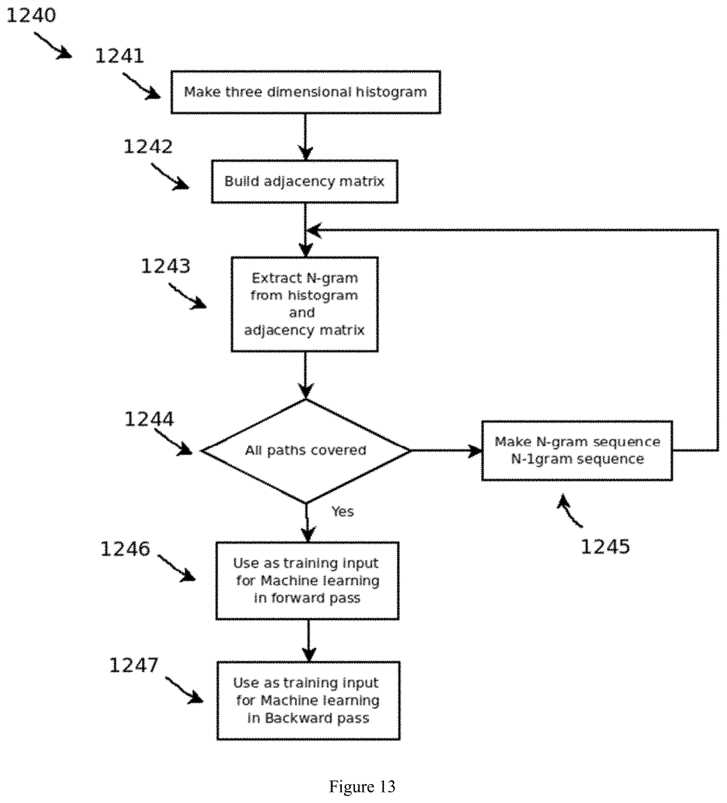

FIG. 13 presents the process of constructing the N-gram sequence and using it to train a machine learning algorithm. A process 1240 starts with a step 1241 that generates the three-dimensional histogram from a cluster generated by subsystem 81 that implements clustering through machine learning. A step 1242 creates the adjacency matrix also from the cluster generated by subsystem 81 that implements clustering through machine learning. A step 1243 extracts the n-gram sequence using pre-selected n-gram length and using step 1241 and step 1242. A step 1244 evaluates all possible paths and determines if all possible paths satisfy the n-gram length, if not a step 1245 reduces the n-gram length to see if it covers the remaining paths not covered. Once the decision of step 1244 is true, a step 1246 uses the N-grams as input for a machine learning algorithm as a forward pass. An exemplary embodiment of the present invention may use the Hidden Markov Model or a recurrent neural network as a machine learning algorithm. An additional step to step 1246 is a step 1247 where the algorithm is trained in a backward pass. An example of a machine learning implementation of step 1247 with step 1246 is the Baum-Welch or bidirectional recurrent neural network.

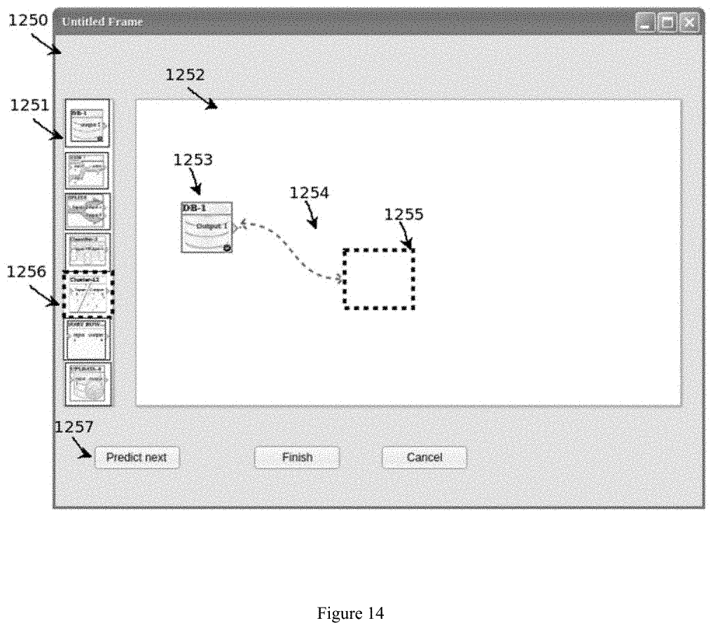

FIG. 14 shows a graphical user interface that implements the output of the process. A graphical user interface 1250 has a menu 1251 that contains a selection of operators that can be used in a canvas 1252. The canvas 1252 is shown as having an operator 1253 that is dropped by the user. As soon as the operator 1253 is placed by the user on the canvas 1252 the background process activates a neural network that will place a link 1254 to an operator placeholder 1255. The operator placeholder 1255 corresponds to an operator 1256 that is in the menu 1251 and this allows the user to see the selection that the machine learning algorithm has predicted as the next operator to be placed in the flow. A button 1257 allows the user to let the machine learning algorithm suggest the next operator to be placed in the canvas.

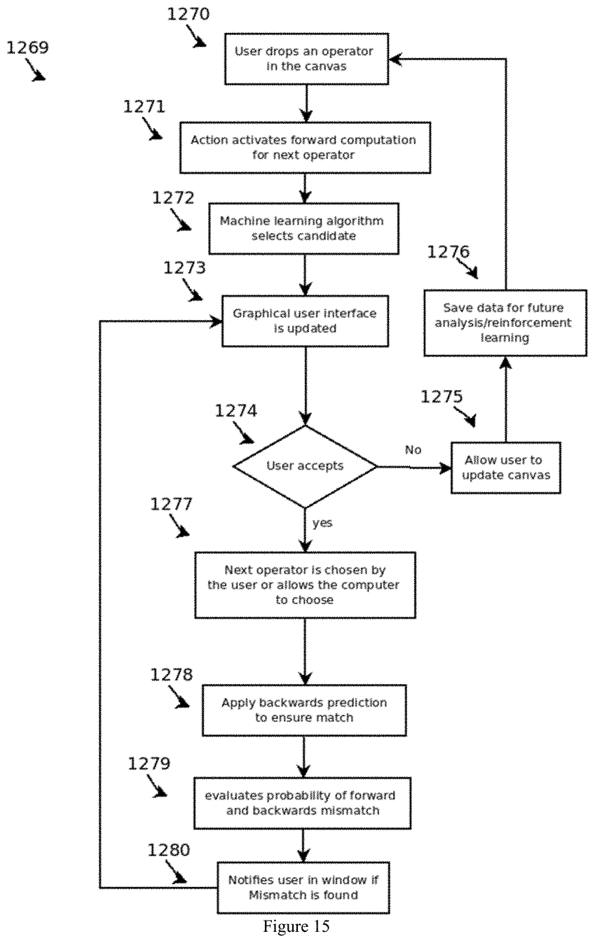

FIG. 15 illustrates the process of the interaction between the operator selection process and the user. A process 1269 starts with a step 1270 where the user selects an operator from menu 1251 and places it on the canvas 1252. The user action of step 1270 triggers a step 1271 where the machine learning algorithm is triggered to do the processing based on the forward computation. The outcome of step 1271 is a step 1272 where the machine learning algorithm generates a candidate output based on the forward computation and is passed to the main process for post processing such as decoding from numerical output to the actual operator name. After step 1272 a step 1273 generates on the graphical interface 1250 and places the link 1254, operator placeholder 1255 and highlights the corresponding operator 1256. The step 1273 is followed by step 1274 where the user decides if the process output is the correct one. If the decision of step 1274 is negative, then a step 1275 allows the user to update the canvas manually and override the machine learning process. A step 1276 will record step 1274 and step 1275 for future processing such as complete retraining or implement reinforcement learning. If step 1274 is true, then a step 1277 takes place and a next operator is allowed to be placed based on the machine learning process. The implementation of step 1277 also triggers a step 1278 where after the machine learning algorithm applies the forward pass in step 1277 step 1278 performs the backward pass to see if there is any mismatch in a step 1279. If step 1279 finds a mismatch, then a step 1280 notifies the user of the mismatch and allows the user to manually intervene.

What is claimed:

1. A method for suggesting a workflow representative of a workflow set using machine learning wherein each workflow in said workflow set comprises a plurality of operators configured in a coordinate grid, comprising the steps of:
generating a three-dimensional histogram representing the frequency for which each of said plurality of operators occurs in each column of said coordinate grid;
generating an adjacency matrix representing said three-dimensional histogram and a plurality of links that connect said plurality of operators in said coordinate grid in each workflow of said workflow set;
determining a maximum n-gram length based on a plurality of n-gram sequences extracted from said three-dimensional histogram and said adjacency matrix;
evaluating all possible paths between operators for each workflow in said workflow set by determining if all possible paths satisfy said maximum n-gram length;
reducing said maximum n-gram length such that all possible paths satisfy said maximum n-gram length; and
using all possible paths that satisfy said maximum n-gram length as input for a machine learning algorithm.

2. The method as in claim 1, where said machine learning algorithm is trained in a forward pass.

3. The method as in claim 1, where said machine learning algorithm is trained in a backward pass.

4. The method as in claim 1, where said machine learning algorithm is the Hidden Markov model.

5. The method as in claim 1, where said machine learning algorithm is a recurrent neural network.

6. The method as in claim 3, where said machine learning algorithm is the Baum-Welch algorithm.

7. The method as in claim 3, where said machine learning algorithm is a bi-directional recurrent neural network.

8. The method as in claim 1, further comprising the step of displaying a user interface wherein said user interface provides operator suggestions for building said workflow representative of a workflow set.

9. The method as in claim 8, wherein said user interface allows a user to manually modify said workflow representative of a workflow set.

10. The method as in claim 9, where said manual modifications are further used as input for said machine learning algorithm.

11. A system for suggesting a workflow representative of a workflow set using machine learning wherein each workflow in said workflow set comprises a plurality of operators configured in a coordinate grid, comprising:
one or more computer processors;
one or more computer readable storage devices;
program instructions stored on said one or more computer readable storage devices for execution by at least one of said one or more computer processors, said stored program instructions comprising:
program instructions for generating a three-dimensional histogram representing the frequency for which each of said plurality of operators occurs in each column of said coordinate grid;
program instructions for generating an adjacency matrix representing said three-dimensional histogram and a plurality of links that connect said plurality of operators in said coordinate grid in each workflow of said workflow set;
program instructions for determining a maximum n-gram length based on a plurality of n-gram sequences extracted from said three-dimensional histogram and said adjacency matrix;
program instructions for evaluating all possible paths between operators for each workflow in said workflow set by determining if all possible paths satisfy said maximum n-gram length;
program instructions for reducing said maximum n-gram length such that all possible paths satisfy said maximum n-gram length; and
program instructions for using all possible paths that satisfy said maximum n-gram length as input for a machine learning algorithm.

12. The system as in claim 11, where said machine learning algorithm is trained in a forward pass.

13. The system as in claim 11, where said machine learning algorithm is trained in a backward pass.

14. The system as in claim 11, where said machine learning algorithm is the Hidden Markov model.

15. The system as in claim 11, where said machine learning algorithm is a recurrent neural network.

16. The system as in claim 13, where said machine learning algorithm is the Baum-Welch algorithm.

17. The system as in claim 13, where said machine learning algorithm is a bi-directional recurrent neural network.

18. The system as in claim 11, further comprising program instructions for displaying a user interface wherein said user interface provides operator suggestions for building said workflow representative of a workflow set.

19. The system as in claim 18, wherein said user interface allows a user to manually modify said workflow representative of a workflow set.

20. The system as in claim 19, where said manual modifications are further used as input for said machine learning algorithm.
